(19) United States
(12) Patent Application Publication
(10) Pub. No.: US 2020/0378527 A1
(43) Pub. Date: Dec. 3, 2020

(54) Valve

(71) Applicant: Alfmeier Prazision SE, Treuchtlingen (DE)

(72) Inventors: Markus Stephan, Gnotzheim (DE); Werner Ruppert, Langenaltheim (DE); Elke Conrad, Weissenburg (DE)

(21) Appl. No.: 16/887,188

(22) Filed: May 29, 2020

(30) Foreign Application Priority Data
May 31, 2019 (DE) 10 2019 114 708.5

(51) Int. Cl. F16K 39/02; F16K 17/04; F16K 1/44

(52) U.S. Cl. CPC F16K 39/024; F16K 1/443; F16K 17/04

(57) ABSTRACT

A valve has a valve housing, at least one valve opening, a valve element movably mounted inside the valve housing along a direction of movement B1, B2 between a closing position and an opening position, at least one spring element to reset the valve element from the opening position to the closing position, a carrier element movably mounted inside the valve housing along the direction of movement B1 and at least one sealing element attached to the carrier element. The at least one sealing element and the carrier element are a multi-component part, and may be for example a two-component part.

### CROSS-REFERENCE TO RELATED APPLICATIONS

This application claims benefit to German Patent Application Number 10 2019 114 708.5, filed May 31, 2019, which is incorporated in its entirety by reference herein.

### TECHNICAL FIELD

The disclosure relates to a valve, especially a valve to protect a fuel tank against an inadmissible excess and/or negative pressure.

### BACKGROUND

Both during operation and standstill, the pressure inside a fuel tank may not fall below or above the limits that have been set. In order to ensure this, valves are used that protect the fuel tank from excess and/or negative pressure that becomes too high. The valves used so far have loose, separate sealing elements that are attached in various ways (e.g. tied or clamped) to a carrier element.

However, this causes the problem that due to its design, the sealing element can be untied from the carrier element or can leave its exact position in the valve when the valve is operated. This can be caused, for example, when the sealing element remains hanging on the sealing surface when the valve is opened, but the remaining built-in parts, including the carrier element, keep moving due to excess or negative pressure that is too high. In this case, the sealing element can remain hanging on the sealing surface either due to gluing effects or freezing.

### SUMMARY

It is the objective of the disclosed subject matter to suggest a valve that is improved with regard to the above-mentioned disadvantages or that provides other advantages.

This object is solved with at least some of the features disclosed below. The valve, especially a valve to protect a fuel tank against inadmissible excess and/or negative pressure, has a valve housing, at least one valve opening and one valve element, which is movably mounted inside the valve housing along a direction of movement between a closing position and at least one opening position, in order to close or open the at least one valve opening. Furthermore, the valve comprises at least one spring element to reset the valve element from the opening position to the closing position. The valve additionally comprises one carrier element, which is movably mounted inside the valve housing along the direction of movement, and at least one sealing element, which is firmly attached to the carrier element. According to the disclosure, the at least one sealing element and the carrier element are a multi-component part, especially a two-component part (“2-C part”).

According to the disclosure, the carrier element and the sealing element are executed as multi-components, especially as a two-component part. A multi-component part is generally understood to be a part manufactured in a process or work step, i.e. various materials are machined in one process to become one part. Thus, the carrier element and the sealing element form one “unit” that is subsequently integrated into the valve or used in it. The multi-component part, especially the two-component part, is manufactured by means of injection molding, for example, and can thus be a multi-component injection molding part or a two-component injection molding part. Moreover, it is possible to manufacture the multi-component part, especially the two-component part, for example, in a way that an injected carrier element is subsequently injection molded with the sealing element or vulcanized on it.

The sealing element has a sealing area that especially includes a sealing edge. In the closing position of the valve opening, the sealing area or sealing edge act together with a sealing surface surrounding the valve opening in order to maintain the valve reliably sealed tightly. When the valve is opened, the sealing element or its sealing area is detached from the sealing surface by a movement of the valve element, thereby opening the valve opening and allowing fluid to flow through. The idea of the disclosure is thus based on providing a connection between the carrier element and the sealing element that is more permanent or one in which the force holding the two components together is stronger than the tensile forces occurring between sealing element and sealing surface due to the adhesive effects. This prevents the detachment of the sealing element from the carrier element when the valve is opened.

In the multi-component part or two-component part, this is especially a so-called “hard-soft” connection, i.e. the carrier element consists of a relatively hard plastic material on which a relatively soft elastomer is attached as sealing element. Materials worth mentioning here are polyamides (PA), polyphthalamides (PPA) or polyphenylene sulfide (PPS), for example. As a rule, glass fiber-reinforced materials or glass-fiber reinforced plastic are used for the carrier element. The soft components of the sealing element can be, for example, silicone rubber (VMQ), fluorosilicone rubber (FVMQ) or fluorocarbon rubber (FCM) sein.

The carrier element and the at least one sealing element are advantageously attached to one another in a mechanical and/or chemical way. The chemical attachment is created when the parts are manufactured and can especially be improved or made possible also by using bonding agents in the carrier element and/or sealing element material. Here, a mechanical attachment is understood to be the linking up of the carrier element and the sealing element with a positive locking acting with and/or against the direction of movement of the valve element in order to additionally prevent a detachment.

In an advantageous embodiment, the execution of the form-fitting connection takes place because the carrier element has at least one through opening through which the at least one sealing element extends. Furthermore, the at least one sealing element engages behind the through opening, especially on both sides.

Another preferred design provides a cavity, executed between the carrier element and a sealing edge or between the carrier element and a sealing area of the at least one sealing element, which especially includes one sealing edge. In other words, the carrier element and/or the sealing element have one or more recesses on their sides facing one another that are oriented flush with the sealing edge or the sealing area in the direction of movement. Such a “hollowing out” of the sealing edge and/or the sealing area has the advantage that the areas of the sealing element acting together with the sealing surface can be more flexibly designed. To manufacture such cavities, the recess can be made in the carrier element, for example, and filled with a material that can be melted out in a temperature process and thus removed once again after the sealing element is applied.

Preferably, the cavity and/or the sealing edge and/or the sealing area are executed in a ring-shaped way, so that they fully surround the at least one valve opening so there is flexibility around the entire valve opening. The sealing area preferably comprises a sealing edge, likewise especially executed in a ring-shaped way, which acts together with the sealing surface surrounding the valve opening.

Since an inadmissible excess and negative pressure can occur especially in a fuel tank, it is advantageous if the valve can provide relief in both cases. To achieve this, the valve in an advantageous embodiment has a first valve opening and a second valve opening, wherein the valve element is movably mounted along the direction of movement between the closing position and a first opening position to open the first valve opening (for example, if there is excess pressure in the fuel tank) and the closing position and a second opening position to open the second valve opening when there is negative pressure in the fuel tank, for example.

In this design, the valve is executed as combined excess and negative pressure valve, wherein both valve openings are controlled by a valve element. Here, the flow cross-section of first valve opening (excess pressure) is larger than the flow cross-section of the second valve opening (negative pressure).

In an advantageous further development, the first valve opening is executed in the valve housing and/or the second valve opening in the carrier element. To open the first valve opening, the valve element moves together with the carrier element and the sealing element, and the sealing element lifts off from a sealing surface surrounding the first valve opening, so that fluid can flow through the first valve opening. In this case, the sealing surface is formed by the valve housing. To open the second valve opening, only the valve element is moved; the carrier element and the sealing element remain in their position and the valve element lifts off from the sealing element, so that fluid can flow through the second valve opening. In this case, the valve element itself forms the sealing surface.

In principle, a sealing element can be provided for each one of the two valve openings. In a preferred embodiment, however, the at least one sealing element has a first sealing area that acts together with a first sealing surface surrounding the first valve opening, and a second sealing area that acts together with a second sealing surface surrounding the second valve opening. In other words, the sealing element is executed as one single piece. The first sealing area preferably has a first sealing edge auf that acts together with the first sealing surface surrounding the first valve opening; the second sealing area preferably has a second sealing edge that acts together with the second sealing surface surrounding the second valve opening.

A first spring element serves to reset the valve element from the first opening position to the closing position, a second spring element to reset the valve element from the second opening position to the closing position.

The valve element has especially a valve head and a valve shaft, wherein the valve shaft or a first section of the valve shaft is movably mounted and guided inside an opening of the carrier element and the valve shaft or a second section of the valve shaft is held in a holding element. The valve head is arranged on a side of the opening opposite the holding element and at least in a closing position makes contact with at least one sealing element and/or the carrier element. The opening of the carrier element forms especially the second valve opening. The carrier element itself is essentially executed in a hollow cylindrical shape and merely has a front side wall on a front side that has the opening and supports the sealing element. The front side merely has the opening for arranging the valve element and is otherwise tightly executed. The cylindrical lateral wall, on the other hand, can additionally have openings through which the fluid can possibly flow.

An advantageous further development provides the holding element with a disk-shaped section and retaining hooks extending from the disk-shaped section in the direction of movement of the valve element that engage on an outer side of the valve shaft and fix the valve element in place inside the holding element.

It is furthermore advantageous if the carrier element has guiding elements on an outer side to guide the carrier element inside the valve housing.

These outer guiding elements are here especially executed as ring-shaped projections surrounding the carrier element in a circumferential direction and/or as one single pieces with the carrier element.

It is furthermore preferred if guiding elements to guide the valve element are provided in the opening of the carrier element.

These inner guiding elements are preferably guiding ribs extending in a direction of movement of the valve element and/or executed as one single pieces with the carrier element.

An advantageous further development additionally provides the valve housing with at least a projection protruding from its inner side that forms a stop surface for the valve element and/or the carrier element in order to restrict the movement of the valve element.

### BRIEF DESCRIPTION OF THE DRAWINGS

The disclosure will be explained in more detail below, also with respect to additional features and advantages, by describing embodiments and with reference to the attached drawings, which show in each case in a schematic diagram:

FIG. 1 is a cross-sectional view showing a valve in closing position;

FIG. 2 is a cross-sectional view of the valve from FIG. 1 in an opening position at excess pressure;

FIG. 3 is a cross-sectional view of the valve from FIG. 1 in an opening position at negative pressure; and

FIG. 4 is an enlarged cross-sectional view of the sealing element and carrier element according to one embodiment.

### DETAILED DESCRIPTION

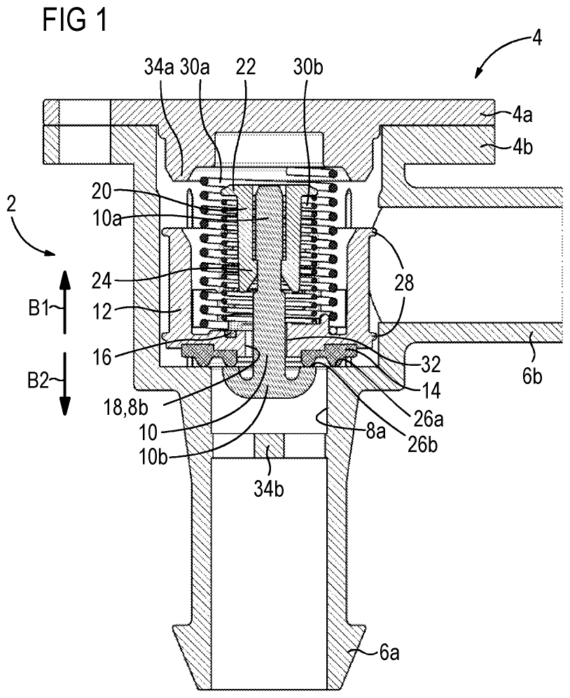

FIG. 1 shows a valve 2 with a valve housing 4, which in this case has a lid 4a and a housing part 4b, in closing position. The valve 2 is provided to protect a fuel tank against pressures that exceed or fall below a threshold. The valve housing 4 has a first connecting piece 6a to connect the valve 2 to the fuel tank and a second connecting piece 6b to connect the valve 2 to the activated charcoal filter or the atmosphere. Here, both connecting pieces 6a, 6b are executed as one single pieces with the valve housing 4, more precisely with the housing part 4b. Furthermore, the valve 2 has a first valve opening 8a and a second valve opening 8b. Inside the valve housing 4, a valve element 10 and a carrier element 12 are movably mounted.

The carrier element 12 and a sealing element 14 firmly attached to it are executed as a two-component part. As a result of this, the carrier element 12 and the sealing element 14 are, on the one hand, already chemically attached to one another. To strengthen the attachment, the carrier element 12 also has several through openings 16 that extend preferably in a direction of movement B1, B2 of the carrier element 12 and through which the sealing element 14 extends. In addition, the sealing element 14 engages the carrier element 12 from behind to ensure an effective form-fitting connection in both direction of movements B1, B2.

The valve element 10 comprises a valve shaft 10a and a valve head 10b. The valve shaft 10a is movably mounted and guided inside an opening 18 of the carrier element 12. Moreover, the valve shaft 10a is held or fixed in place in a holding element 20. To achieve this, the holding element 20 has a disk-shaped section 22, on which an end section of the valve shaft 10a is opposite the valve head 10b rests, and several, especially three, retaining hooks 24 extending from the disk-shaped section 22 in the direction of movement B2 and fix the valve element 10 or the valve shaft 10a in place between them. The valve head 10b is arranged on a side of the opening 18 opposite the holding element 20. In FIG. 1 (which shows the closing position), the valve head 10b abuts the sealing element 14.

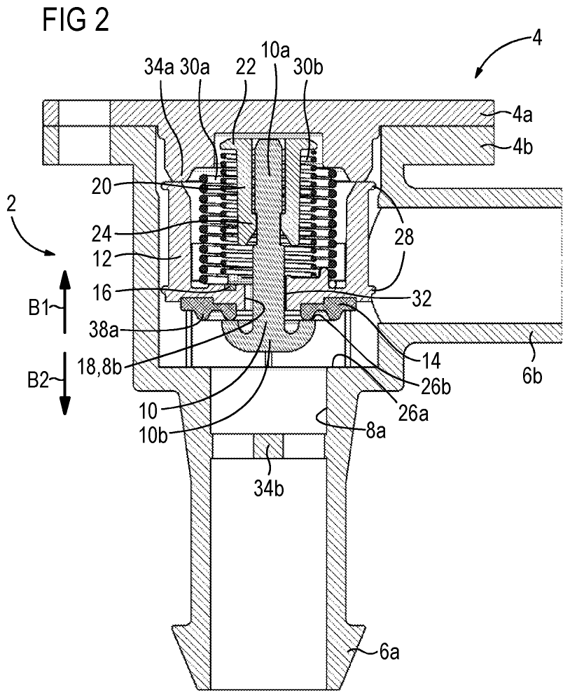

If inadmissible excess pressure prevails in the fuel tank, the valve 2 or its first valve opening 8a is opened. FIG. 2 shows the valve 2 in this first opening position when there is excess pressure in the fuel tank (for the sake of clarity, the components primarily relevant for the excess pressure valve function are provided with reference signs). Here, the valve element 10, the holding element 20 and the carrier element 12 are moved together with the sealing element 14 from the closing position (FIG. 1) in a direction of movement B1 to the first opening position (FIG. 2) and the first valve opening 8a (which is here executed in the valve housing 4, more precisely in the housing part 4b) is opened. When this occurs, the sealing element 14 lifts off from a sealing surface 26a surrounding the valve opening 8a that is here formed by the valve housing 4. The firm attachment between carrier element 12 and sealing element 14 prevents the sealing element 14 from detaching from it, thereby guaranteeing a reliable and fast opening of the valve 2 when there is excess pressure in the fuel tank. So the carrier element 12 moves with as little friction as possible inside the valve housing 4 and prevents the carrier element 12 from tilting, the carrier element 12 has on its outer side ring-shaped projections 28 surrounding it in a circumferential direction that serve as guiding elements. The projections 28 are additionally executed as one single pieces with the carrier element 12. In order to restrict the movement of the valve element 10 in direction of movement B1, the valve housing 4 has a ring-shaped projection 34a protruding from its inner side that forms a stop surface for the carrier element 12. To reset the valve element 10 from the first opening position to the closing position after the excessive pressure has been reduced, the valve 2 has a first spring element 30a. The first spring element 30a is arranged inside the carrier element 12 and grasps the valve element 10 or its valve shaft 10b. The first spring element 30a rests with a first end on the valve housing 4, more precisely on the lid 4a, and with a second end on an inner side of the carrier element 12.

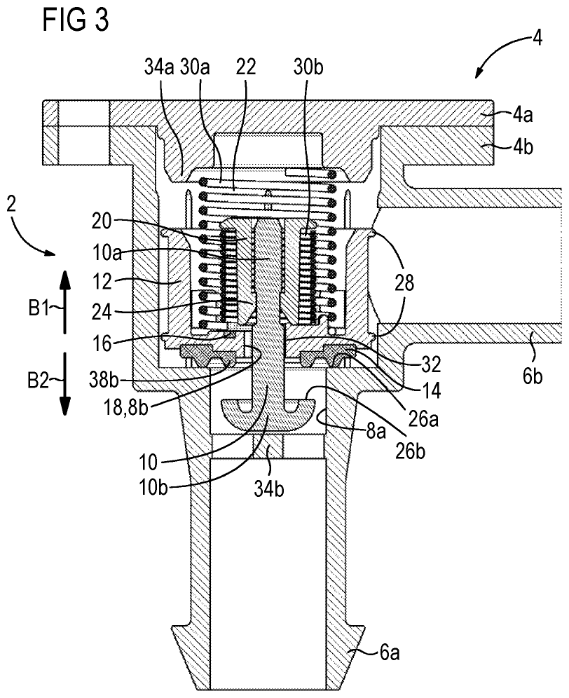

If inadmissible negative pressure prevails in the fuel tank, the valve 2 or its second valve opening 8b is opened. FIG. 3 shows the valve 2 in this second opening position when there is negative pressure in the fuel tank (for the sake of clarity, the components primarily relevant for the negative pressure valve function are provided with reference signs). Here, the valve element 10 and the holding element 20 are moved from the closing position (FIG. 1) in a direction of movement B2 to the second opening position (FIG. 3) and the second valve opening 8b is opened. Here, the second valve opening 8b is executed in the carrier element 12, more precisely in its front side wall, and corresponds to the opening 18, inside which the valve element 10 or its valve shaft 10a is guided. When the second valve opening 8b is opened, the valve element 10—more precisely, the valve head 10b—forms a sealing surface 26b surrounding the valve opening 8b, from which the sealing element 14 is detached. Here, the firm attachment between carrier element 12 and sealing element 14 also prevents the sealing element 14 from moving together with the valve element 10 and thus detach from the carrier element 12. Thus, a reliable and fast opening of the valve 2 is also guaranteed when there is negative pressure in the fuel tank. In order to restrict the movement of the valve element 10 inside the opening 18 of the carrier element 12 with as little friction as possible and preventing a tilting of the valve element 10 in the opening 18, guiding ribs 32 extending in the direction of movement are available in the opening 18 and executed as one single pieces with the carrier element 12. To restrict the movement of the valve element 10 in direction of movement B2, the valve housing 4 has a projection 34b protruding from its inner side that forms a stop surface for the valve head 10b. To reset the valve elements 10 from the second opening position to the closing position after the negative pressure has been reduced, the valve 2 has a second spring element 30b. The second spring element 30b is, in turn, arranged inside the carrier element 12 and grasps the valve element 10 or its valve shaft 10a. The second spring element 30b rests with a first end on the holding element 20, more precisely on its disk-shaped section 22, and with a second end on the inner side of the carrier element 12.

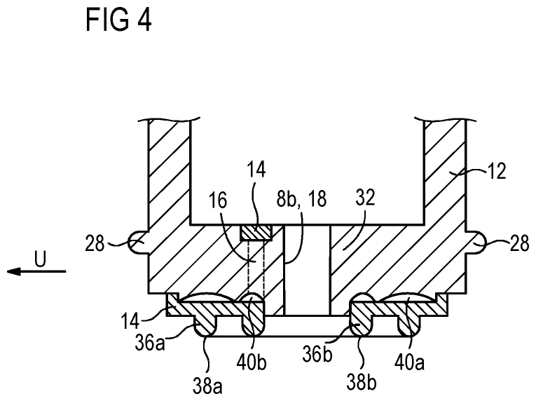

FIG. 4 shows an enlarged view of the carrier element 12 and the sealing element 14 according to an embodiment. The sealing element 14 is executed here as one single piece and has a first sealing area 36a and a second sealing area 36b. The first sealing area 36a comprises a first sealing edge 38a that acts together with the sealing surface 26a surrounding the first valve opening 8a (not shown in FIG. 4). The second sealing area 36b comprises a second sealing edge 38b that acts together with the sealing surface 26b surrounding the second valve opening 8b (not shown in FIG. 4). Owing to the line-shaped contact area, sealing edges 38a, 38b have the advantage that possible irregularities on the sealing surfaces 26a, 26b can be better compensated, so a better tightness of the valve 2 can be achieved.

A cavity 40a, 40b has been executed in each case between the carrier element 12 and the sealing areas 36a, 36b of the sealing element 14 so the sealing area 36a, 36b and the sealing edges 38a, 38b can be more flexibly designed. Here, the cavities 40a, 40b extend in circumferential direction U on both sides beyond the sealing edges 38a, 38b. Both the cavities 40a, 40b and the sealing area 36a, 36b as well as the sealing edges 38a, 38b are executed in a ring-shaped way. In this case, the cavities 40a, 40b are separately executed from one another, but a joint cavity for both sealing areas 36a, 36b and sealing edges 38a, 38b is also conceivable.

### LIST OF REFERENCE NUMERALS

2 Valve
4 Valve housing
4a Lid of the valve housing
4b Housing part of the valve housing
6a, 6b Connecting pieces
8a First valve opening
8b Second valve opening
10 Valve element
10a Valve shaft of the valve element
10b Valve head of the valve element
12 Carrier element
14 Sealing element
16 Through opening of the carrier element
18 Opening of the carrier element
20 Holding element
22 Disk-shaped section of the holding element
24 Retaining hook
26a Sealing surface of the valve housing
26b Sealing surface of the valve element
28 Projections
30a First spring element
30b Second spring element
32 Guiding ribs
34a Projection
34b Projection
36a First sealing area of the sealing element
36b Second sealing area of the sealing element
38a First sealing edge
38b Second sealing edge
40a Cavity
40b Cavity
B1 Direction of movement from closing position to first opening position
B2 Direction of movement from closing position to second opening position
U Circumferential direction

1. A valve comprising:
a valve housing;
at least one valve opening defined in the housing;
a valve element movably mounted inside the valve housing along a direction of movement B1, B2 between a closing position and an opening position;
at least one spring element configured to reset the valve element from the opening position to the closing position;
a carrier element movably mounted inside the valve housing along the direction of movement; and
at least one sealing element connected to the carrier element, the at least one sealing element and the carrier element being configured as a multi-component part, especially a two-component part.

2. The valve according to claim 1, wherein the carrier element and the at least one sealing element are at least one of mechanically and chemically attached to one another.

3. The valve according to claim 2, wherein the carrier element defines at least one through opening through which the at least one sealing element extends and engages the at least one sealing element from behind.

4. The valve according to claim 1, wherein a cavity is defined between the carrier element and a sealing edge of the at least one sealing element or between the carrier element and a sealing area.

5. The valve according to claim 4, wherein at least one of the cavity, the sealing edge, and the sealing area is configured in a ring shape.

6. The valve according to claim 1, wherein the valve defines a first valve opening and a second valve opening, wherein the valve element is movably mounted along the direction of movement B1 between the closing position and a first opening position to open the first valve opening and along the direction of movement B2 between the closing position and a second opening position to open the second valve opening.

7. The valve according to claim 6, wherein at least one of the first valve opening is located in the valve housing and the second valve opening is located in the carrier element.

8. The valve according to claim 6, wherein the at least one sealing element has a first sealing area that acts together with a sealing surface surrounding the first valve opening, and has a second sealing area that acts together with a sealing surface surrounding the second valve opening.

9. The valve according to claim 1, wherein the valve element has a valve shaft and a valve head, wherein the valve shaft is movably mounted and guided inside an opening defined in the carrier element along the direction of movement B2 and held in a holding element, and wherein the valve head is arranged on a side of the opening opposite the holding element and, at least in the closing position, makes contact with at least one of the at least one sealing element and the carrier element.

10. The valve according to claim 9, wherein the holding element has a disk-shaped section and retaining hooks that extend from the disk-shaped section in direction of movement B2 of the valve element.

11. The valve according to claim 1, wherein the carrier element has guiding elements on an outer side to guide the carrier element inside the valve housing.

12. The valve according to claim 11, wherein the guiding elements are configured at least one of as ring-shaped projections surrounding the carrier element in a circumferential direction and unitarily as one single piece with the carrier element.

13. The valve according to claim 1, wherein guiding elements are located in the opening of the carrier element to guide the valve element.

14. The valve according to claim 13, wherein the guiding elements are configured as at least one of guiding ribs extending in a direction of movement B1, B2 of the valve element and unitarily as one single piece with the carrier element.

15. The valve according to claim 1, wherein the valve housing has at least one projection protruding from an inner side that forms a stop surface for at least one of the valve element and the carrier element.
